(19) United States
(12) Patent Application Publication
(10) Pub. No.: US 2018/0101805 A1
(43) Pub. Date: Apr. 12, 2018

(54) SYSTEM AND METHOD FOR GOAL-ORIENTED BIG DATA BUSINESS ANALATICS FRAMEWORK

(71) Applicant: Eunjung Park, Seoul (KR)

(72) Inventor: Eunjung Park, Seoul (KR)

(21) Appl. No.: 15/698,157

(22) Filed: Sep. 7, 2017

(30) Foreign Application Priority Data
Oct. 7, 2016 (KR) 10-2016-0129558

(51) Int. Cl. G06Q 10/06; G06N 7/00; G06N 99/00; G06F 17/30

(52) U.S. Cl. CPC G06Q 10/06393; G06Q 10/0633; G06Q 10/06375; G06Q 10/067; G06F 17/30929; G06N 99/005; G06F 17/30908; G06F 17/30941; G06N 7/005

(57) ABSTRACT

A method performed by a computing system comprises setting up a business goal, a business process goal, and an performance goal, modeling a hypothesized solution under a hypothesis where a first phenomenon is a solution, determining that the hypothesized solution is a validated solution when the hypothesized solution is determined to make a positive contribution based on a result of analysis of first big data on the hypothesized solution, modeling a plurality of business process alternatives by modifying an activity or task based on a plurality of validated solutions, assessing a degree of an influence that each of the business process alternatives has on at least any one of the business goal, the business process goal, and the performance goal, and determining a core validated solution of the plurality of validated solutions based on a result of the assessment.

### CROSS-REFERENCE TO RELATED APPLICATIONS

This patent application claims priority under 35 U.S.C. § 119 to Korean Patent Application No. 10-2016-0129558, filed on Oct. 7, 2016, in the Korean Intellectual Property Office, the disclosure of which is incorporated by reference herein in its entirety.

### TECHNICAL FIELD

Embodiments of the present disclosure concern a computing system performing goal-oriented big data business analytics, a goal-oriented big data business analytics framework, and a computer executed method by the computing system.

### DISCUSSION OF RELATED ART

Big data analytics is the process of examining large and varied data sets, such as social media service data, real-time machine-to-machine (M2M) sensor data, business-customer relationship data, or any other data, to uncover hidden patterns, unknown correlations, market trends, customer preferences and other useful information that can help organizations make more-informed business decisions.

Big data refers to data sets that are so large or complex that traditional data processing application software is inadequate to deal with them. Big data includes not only table schemas for online transactions and structured data stored in databases based on the relationship between the table schemas, but also unstructured data explosively generated in various environments, such as mobile, Internet, cloud computing, social media services, or location-based services, and semi-structured data, such as log data generated by various computing processes.

Big data conventionally has 4-V properties, i.e., Volume: big volume, Velocity: high speed to generate and process data, Variety: diverse data source, and Veracity: uncertainty of data quality). Big data has recently added Value and is now referred to as 5 Vs.

For effective analytics of big data including structured data, unstructured data, and semi-structured data becomes more critical, IBM, SAP, MS, Google or other big companies have been making a huge investment in business analytics (BA) and business intelligence (BI) sectors. Further, continuous research efforts are underway for machine learning, data mining, and data visualization.

### SUMMARY

According to an embodiment of the present disclosure, there are provided a system and method capable of supporting a more reliable business decision by deriving various solutions for achieving a business goal and selecting the optimal one among the solutions according to a goal-oriented approach using big data.

According to an embodiment of the present disclosure, there are provided a system and method contributing to an exact business decision by considering a business context such as the overall business goal or business process as going one step further from big data-based analysis of individual phenomena in a business context.

According to an embodiment of the present disclosure, there are provided a system and method capable of validating business-related problems and solutions by big data analytics, reviewing various alternatives, and figuring out the most appropriate problem and solution.

According to an embodiment of the present disclosure, there is provided an integrated language that may support a goal-oriented big data business analytics framework or system and that is applicable at various levels including a business level, system level, and software architecture level.

It, however, should be noted that the present disclosure is not limited thereto.

According to an embodiment of the present disclosure, a method performed by a computing system performing goal-oriented big data business analytics comprises setting up a business goal, a business process goal that is a goal for an activity or task related to a process for achieving the business goal, and an performance goal for the business goal or the business process goal, modeling a hypothesized solution under a hypothesis where a first phenomenon is a solution that is a phenomenon positively contributing to achieving at least any one of the business goal, the business process goal, and the performance goal, determining that the hypothesized solution is a validated solution when the hypothesized solution is determined to make a positive contribution based on a result of analysis of first big data on the hypothesized solution by a big data analytics platform connected with the computing system, modeling a plurality of business process alternatives by modifying the activity or task based on a plurality of validated solutions determined by the determining step, assessing a degree of an influence that each of the business process alternatives has on at least any one of the business goal, the business process goal, and the performance goal, and determining a core validated solution of the plurality of validated solutions based on a result of the assessment. The degree of the influence may be previously divided into a plurality of labels indicating a positive degree or a negative degree.

According to an embodiment of the present disclosure, the method may further comprise modeling a hypothesized problem under a hypothesis where a second phenomenon corresponds to a problem that is a phenomenon negatively contributing to achieving at least any one of the business goal, the business process goal, and the performance goal, and determining that the hypothesized problem is a validated problem when the hypothesized problem is determined to be a phenomenon making a negative contribution based on a result of analysis of second big data on the hypothesized problem by the big data analytics platform. Modeling the hypothesized solution may include modeling the hypothesized solution under a hypothesis where the first phenomenon corresponds to the solution that is a phenomenon capable of addressing the validated problem.

According to an embodiment of the present disclosure, the method may further comprise providing a user interface (UI) configured to visualize data corresponding to a result of performing at least one of the steps and display the visualized data.

According to an embodiment of the present disclosure, providing the UI may include a business context integrated language configured based on a soft-goal interdependence graph (SIG), a problem interdependence graph (PIG), and a business process model and notation (BPMN) in a non-functional requirement (NFR) framework.

According to an embodiment of the present disclosure, the business context integrated language may model the big data and a big query on a big data analytics platform configured to analyze the big data.

According to an embodiment of the present disclosure, the hypothesized problem, the validated problem, the hypothesized solution, and the validated solution may be represented in a combination of a Type item and a Topic item. The Type item may indicate a non-functional attribute value, and the Topic item may indicate a functional attribute value corresponding to the Type item. The Topic item may correspond to an element constituting a business process written in the BPMN.

According to an embodiment of the present disclosure, modeling the hypothesized problem may include modeling multiple hypothesized problems for the first phenomenon by negating the performance goal, and modeling the hypothesized solution may include modeling multiple hypothesized solutions for the second phenomenon by negating the validated problem.

According to an embodiment of the present disclosure, the task or activity may include a plurality of sub activities or sub tasks configured in hierarchy. Modeling the hypothesized problem may use at least one of a top-down scheme in which the sub tasks or sub activities are reviewed from an outermost sub task or sub activity to an innermost sub task or sub activity, a bottom-up scheme in which the sub tasks or sub activities are reviewed from the innermost sub task or sub activity to the outermost sub task or sub activity, and a hybrid scheme which is a combination of the top-down scheme and the bottom-up scheme to model a root cause for multiple hypothesized problems for the first phenomenon. Modeling the hypothesized solution may use at least one of the top-down scheme, the bottom-up scheme, and the hybrid scheme to model a core hypothesized solution of the multiple hypothesized solutions for the second phenomenon.

According to an embodiment of the present disclosure, the method may further comprise selecting a core validated solution of the plurality of validated solutions based on a result of assessing a degree of a positive influence that the plurality of validated solutions have on the achievement of at least any one of the business goal, the business process goal, and the performance goal, selecting a core validated problem of a plurality of validated problems determined by the determining step based on a result of assessing a degree of a negative influence that the plurality of validated problems have on the achievement of at least any one of the business goal, the business process goal, and the performance goal, and selecting a final business process alternative of the plurality of business process alternatives based on at least one of the core validated solution, the core validated problem, and the results of the assessment.

According to an embodiment of the present disclosure, the method may further comprise comparing advantages and disadvantages of a plurality of conducting agents according to a label propagation algorithm to select a final conducting agent and assigning one activity or task of the plurality of business process alternatives to the final conducting agent.

According to an embodiment of the present disclosure, the method may further comprise collecting and analyzing monitoring information about a process of performing the assigned activity or task by the final conducting agent and resetting at least any one of the business goal, the business process goal, and the performance goal based on the monitoring information.

According to an embodiment of the present disclosure, the business goal, the business process goal, and the performance goal each may be set to depend upon a stakeholder of a business.

According to an embodiment of the present disclosure, a big query configured to analyze the big data may be configured in at least any one of a structured query language (SQL) language, a non-SQL (NoSQL) language, and a language for a machine learning algorithm-based analysis and is used to query about multiple databases (DBs) stored in an integrated big data platform.

According to an embodiment of the present disclosure, the method may further comprise performing, by a label propagation algorithm, at least one of comparing advantages and disadvantages of a plurality of big queries configured to analyze the big data to select a final big query, comparing advantages and disadvantages of a plurality of validated problems to select a final validated problem, comparing advantages and disadvantages of the plurality of validated solutions to select a final validated solution, and comparing advantages and disadvantages of a plurality of business process alternatives to select a final business process alternative.

According to an embodiment of the present disclosure, the method may further comprise configuring a business goal-business process map that indicates whether a higher business process positively or negative contributes to the achievement of the business goal using an analysis of a correlation between the performance goal and the activity or task.

According to an embodiment of the present disclosure, the big data may be analyzed by a machine learning algorithm. The big data may include analysis data, such as an inter-data correlation, optimization data, and prediction data.

According to an embodiment of the present disclosure, a computer-readable storage medium may store a program to execute the method.

According to an embodiment of the present disclosure, a computing system performing goal-oriented big data business analytics may comprise a memory storing a plurality of commands and a processor connected with the memory. The plurality of commands may be executed by, e.g., the processor, to enable the processor to perform the operations of setting up a business goal, a business process goal that is a goal for an activity or task related to a process for achieving the business goal, and an performance goal for the business goal or the business process goal, modeling a hypothesized problem under a hypothesis where a first phenomenon corresponds to a problem that is a phenomenon negatively contributing to achieving at least any one of the business goal, the business process goal, and the performance goal, determining that the hypothesized problem is a validated problem when the hypothesized problem is determined to make a negative contribution based on a result of analysis of first big data on the hypothesized problem by a big data analytics platform connected with the computing system, modeling a hypothesized solution under a hypothesis where a second phenomenon is a solution that is a phenomenon positively contributing to achieving at least any one of the business goal, the business process goal, and the performance goal or capable of addressing the validated problem, determining that the hypothesized solution is a validated solution when the hypothesized solution is determined to make a positive contribution based on a result of analysis of second big data on the hypothesized solution by the big data analytics platform, modeling a plurality of business process alternatives by modifying the activity or task based on a plurality of validated solutions determined by the determining operation, assessing a degree of an influence that each of the business process alternatives has on at least any one of the business goal, the business process goal, and the performance goal, and determining a final validated problem of a plurality of validated problems or a final validated solution of the plurality of validated solutions based on a result of the assessment. The degree of the influence may be previously divided into a plurality of labels indicating a positive degree or a negative degree.

According to an embodiment of the present disclosure, the computing system may further comprise a user interface (UI) configured to visualize data corresponding to a result of performing at least one of the commands and display the visualized data.

According to an embodiment of the present disclosure, a system includes a goal-oriented big data business analytics framework. The goal-oriented big data business analytics may comprise a business context modeler and processing components including a business goal, a business process goal that is a goal for an activity or task related to a process for achieving the business goal, an performance goal for the business goal or the business process goal, and a problem and solution related to the activity or task, and big query and big data and displaying the components on a screen of a display, an integrated big data platform collecting and storing multiple pieces of data, a big data analytics platform analyzing data of the integrated big data platform and validating a hypothesis made for the problem and solution based on a result of the analysis, and a data visualizer displaying data corresponding to the result of the analysis and a result of the validation on the screen. The system may model a plurality of business process alternatives by modifying the activity or task based on a plurality of validated solutions, assesses a degree of an influence that each of the plurality of business process alternatives has on achieving at least any one of the business goal, the business process goal, and the performance goal, and determines a final validated problem of a plurality of validated problems or a final validated solution of the plurality of validated solutions based on a result of the assessment of each business process alternative. The degree of the influence may be previously divided into a plurality of labels indicating a positive degree or a negative degree.

According to an embodiment of the present disclosure, the use of both a data-oriented approach and a goal-oriented approach enhances a business process to be what is intended to be achieved, creating a new value through big data and leading to an efficient design of the way to which all or individual activities or tasks related to the business proceed.

According to an embodiment of the present disclosure, a process for validating multiple hypothesized problems and hypothesized solutions directly or indirectly related to a base station is carried out, contributing to setting up a goal related to the business and a future way. The goal reflects various points of view and present positive outcomes to all the stakeholders of the business (including service providers and service customers).

According to an embodiment of the present disclosure, the optimal problem, solution, big query, and conducting agent of multiple problems, solutions, big queries, and conducting agents are chosen and applied. Thus, increase reliability and accuracy may be attained in a business decision. Quantitative or qualitative assessment or various machine learning algorithms are combined together to compare the advantages and disadvantages of each alternative.

According to an embodiment of the present disclosure, the process of validating problems or solutions may combine queries and data to be analyzed in various manners, leading to increased reliability and accuracy in a business decision.

According to an embodiment of the present disclosure, a user interface is configured using an integrated language for modeling a business context, affording stakeholders more convenience in communication and a better understanding.

According to an embodiment of the present disclosure, requirements for a software system to enhance a business process may be extracted. It may also be monitored in real-time whether an enhanced activity or task is performed as intended, thus enabling a steady check and reflection of feedbacks for the business process.

According to an embodiment of the present disclosure, there may be provided a system capable of tracing major concepts including business goal, business process goal, performance goal, business process, business-related problem and solution, stakeholder, enhanced business process, conducting agent, big query, big data, and software system requirements. An end-to-end flow and process may efficiently be managed.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating ontology showing major concepts and a relationship among the major concepts in goal-oriented big data business analytics according to an embodiment of the present disclosure;

FIG. 2 is a view illustrating an example of a computing system performing goal-oriented big data business analytics and an example of a whole system including the computing system according to an embodiment of the present disclosure;

FIG. 3 is a flowchart illustrating a process performed by a computing system performing goal-oriented big data business analytics according to an embodiment of the present disclosure;

FIG. 4 is a view illustrating a process in which a computing system performing goal-oriented big data business analytics validates problems and solutions based on a big query or big data analytics result according to an embodiment of the present disclosure;

FIG. 5 is a view illustrating an architecture for a tool supporting a goal-oriented big data business analytics framework or system according to an embodiment of the present disclosure;

FIG. 6 is a view illustrating an example of a business goal-business process map related to a car sales business according to an embodiment of the present disclosure;

FIG. 7 is a view illustrating an example of a process for setting up a goal related to a clothing business and validating problems with the goal according to an embodiment of the present disclosure;

FIG. 8 is a view illustrating a process for validating a solution for a goal related to a clothing business according to an embodiment of the present disclosure;

FIG. 9 is a view illustrating examples of two alternative processes for modifying a business process related to a clothing business according to an embodiment of the present disclosure;

FIG. 10 is a view illustrating an example of a process for extracting software system requirements from a business process modified in relation to a car sales business according to an embodiment of the present disclosure;

FIG. 11 is a view illustrating examples of screen shots of monitoring a procedure as per a business process modified in relation to a clothing business according to an embodiment of the present disclosure;

FIG. 12a is a view illustrating an example of a user interface implemented by a tool for performing a method for executing a computer according to an embodiment of the present disclosure: and

FIG. 12b is a view illustrating an example of a user interface implemented by a tool for performing a method for executing a computer according to an embodiment of the present disclosure.

### DETAILED DESCRIPTION OF EMBODIMENTS

Hereinafter, exemplary embodiments of the present disclosure will be described in detail with reference to the accompanying drawings. The present disclosure, however, may be modified in various different ways, and should not be construed as limited to the embodiments set forth herein. Like reference denotations may be used to refer to the same or similar elements throughout the specification and the drawings. However, the present disclosure may be implemented in other various forms and is not limited to the embodiments set forth herein. For clarity, components or parts irrelevant to the present disclosure are omitted from the drawings or the detailed description. As used herein, the singular forms “a,” “an,” and “the” are intended to include the plural forms as well, unless the context clearly indicates otherwise.

In embodiments of the present disclosure, when an element is “connected” with another element, the element may be “directly connected” with the other element, or the element may be “electrically connected” with the other element via an intervening element. When an element “includes” another element, the element may further include the other element, rather excluding the other element, unless particularly stated otherwise.

<Ontology of Goal-Oriented Big Data Business Analytics Framework>

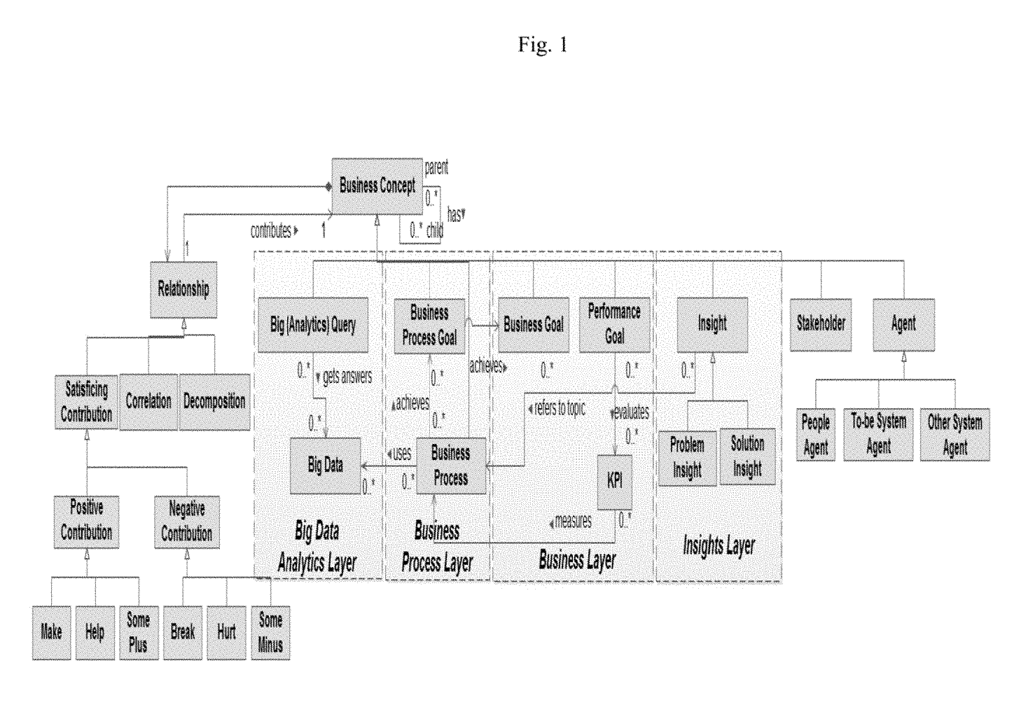

FIG. 1 is a view illustrating ontology showing major concepts and a relationship among the major concepts in goal-oriented big data business analytics according to an embodiment of the present disclosure. The ontology illustrated in FIG. 1 shows business-related major concepts or components, a relationship among them, and a combination thereof as proposed herein. The major concepts are defined as follows.

The term “business goal” may refer to a goal that a business intends to achieve or a statement. Here, the business goal may have a hierarchical architecture and may thus include a higher business goal and a lower business goal corresponding to the higher business goal.

The term “business process” may collectively refer to an action, activity, or task related to the process of achieving a business goal or directly or indirectly related to a business. Here, the action, activity, or task may have a hierarchical architecture and may thus include a plurality of sub actions, sub activities, or sub tasks. The action, activity, or task may have a higher-and-lower architecture and may thus be the concept of encompassing a higher action, higher activity, or higher task and a lower action, lower activity, or lower task corresponding thereto.

The term “business process goal” may refer to a goal that an action, activity, or task related to a process for achieving a business goal intends to achieve or a statement.

The term “performance goal” may refer to a measurable goal for achieving a business goal or a business process goal. The performance goal may be expressed as, e.g., a key performance indicator (KPI) or a predetermined value.

The term “stakeholder” may refer to a person or group associated with a business. The stakeholder may be an entity that owns a business goal or a business process goal.

The term “positive contribution” may refer to a relationship helping to achieve a predetermined goal, or there being a plus. According to the degree of a positive contribution, the positive contribution may be strongly positive, positive, and weakly positive. When a positive contribution is strongly positive, it may be denoted as ‘Make’ which may mean that the contribution or relationship may make a predetermined goal. When a positive contribution is positive, it may be denoted as ‘Help’ which may mean that the contribution or relationship is helpful for a predetermined goal. When a positive contribution is weakly positive, it may be denoted as ‘Some Plus’ which may mean that the contribution or relationship may be a plus to a predetermined goal.

The term “negative contribution” may refer to a relationship hurting a predetermined goal. According to the degree of a negative contribution, the negative contribution may be strongly negative, negative, or weakly negative. When a negative contribution is strongly negative, it may be denoted as ‘Hurt’ which may mean that the contribution or relationship may hurt a predetermined goal. When a negative contribution is negative, it may be denoted as ‘Break’ which may mean that the contribution or relationship may break a predetermined goal. When a negative contribution is weakly negative, it may be denoted as ‘Some Minus’ which may mean that the contribution or relationship may be a minus to a predetermined goal.

The term “phenomenon” (or insight) may refer to at least one event that is observable. The phenomenon may be one related to a business process or may be related to an activity or task associated with a process for achieving a predetermined business goal. The term “first phenomenon” or the term “second phenomenon” may denote any phenomenon. According to embodiments of the present disclosure, the first phenomenon and the second phenomenon may be the same or different from each other.

The term “problem” may refer to a phenomenon (or insight) or event that has a negative effect on achieving a business goal or business process goal. Here, the problem may have a hierarchical architecture and may thus include a plurality of sub problems. The problem may have a higher-and-lower architecture and may thus include a higher problem and a lower problem corresponding to the higher problem.

The term “solution” may refer to a phenomenon (or insight) or event that has a positive effect on achieving a business goal or business process goal. Here, the solution may have a hierarchical architecture and may thus include a plurality of sub solutions. The solution may have a higher-and-lower architecture and may thus include a higher solution and a lower solution corresponding to the higher solution.

Big data may be data that features five Vs (5 Vs), e.g., high Volume, high Velocity, high Variety, high Veracity, and Value. An integrated big data platform includes multiple databases consisting of multiple fields of data, and the integrated big data platform collects and stores multiple pieces of 5V-data.

The term “big query” may refer to a query configured to analyze big data. According to embodiments, a first big query and a second big query, as used herein, may be the same or different from each other.

The term “agent” or “conducting agent” may refer to a subject or entity that conducts or executes a business process. For example, the agent or conducting agent may be a person which is referred to as a people agent, a system to be developed, which is referred to as a to-be-developed system agent, or other systems which are referred to as other system agents.

As such, the major concepts and their relationship in the goal-oriented big data business analytics framework are provided through the ontology shown in FIG. 1.

<Major Technical Spirit Proposed Herein>

According to the present disclosure, there is proposed a business context integrated language for supporting the ontology. The business context integrated language may model a business goal, a business process, a business process goal, a business-related problem and solution, an performance goal (including a KPI), big data, and a big query. The business context integrated language may be a language obtained by integrating existing Goal-Orientated Requirements Engineering (GORE) such as NFR framework, KAOS, and i*, Problem Interdependency Graph (PIG), which is a problem analyzing language using GORE, and Business Process Model and Notation (BPMN) for modeling business process.

As used herein, the term “business context” may refer to a context, situation, or circumstance for a thing or event related to a business when an individual organization or stakeholder carries out a predetermined business. The business context may be associated not only with the business-related major concepts (including business goal, business process goal, performance goal, KPI, business process, business-related problem and solution, and stakeholder) as shown in the ontology of FIG. 1 but also with an information system for supporting the major concepts and data derived therefrom.

According to the present disclosure, there is proposed a process for hypothesizing and validating business-related problems and solutions using the business context integrated language.

The proposed process is described below in detail with reference to the drawings. Basic steps of the process are as follows.

First, various elements related to a business process are set up. As a business goal, business process goal, performance goal, or stakeholder is set up, a business process at a particular time may be modeled.

Next, a business-related problem(s) is diagnosed. At least one problem is hypothesized for the business process at the particular time. The hypothesized problem is validated through a result by a big query or a result of analysis of big data.

The diagnosis of problem may include explicitly modeling the hypothesized problem and the validated problem in the business process and reviewing various alternatives to select an optimal alternative by a goal-oriented approach. The diagnosis of problem may selectively be performed according to an embodiment of the present disclosure.

A business-related solution(s) is then produced. At least one solution is hypothesized for the business process at the particular time. The hypothesized solution is validated through a result by a big query or a result of analysis of big data.

Similar to the diagnosis of problem, deriving the solution may include explicitly modeling the hypothesized solution and the validated solution by the business process and reviewing various alternatives to select an optimal alternative by a goal-oriented approach.

Subsequently, a step for enhancing the business process at the particular time into a to-be business process using the validated solution may be carried out.

As additional steps, a conducting agent may be assigned using the validated solution, and performing a business process by the assigned conducting agent may be monitored. Various elements or components initially set up in relation to the business process may be reset using monitoring information.

According to the present disclosure, there is also proposed a tool for supporting a goal-oriented big data business analytics framework.

The supporting tool may include a business context modeler and a big data analytics platform integrated with big data platform. The supporting tool may also include a component for visualizing each piece of data.

The technical spirit as proposed herein is described below in greater detail with reference to the accompanying drawings.

<Computing System Performing Goal-Oriented Big Data Business Analytics>

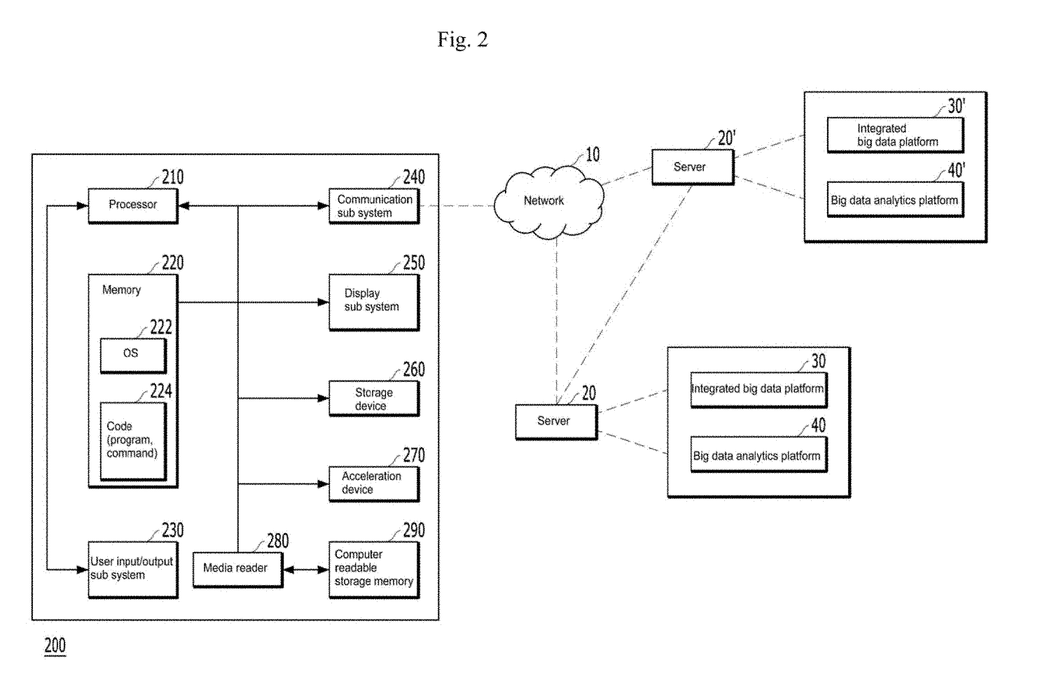

FIG. 2 is a view illustrating an example of a computing system performing goal-oriented big data business analytics and an example of a whole system including the computing system according to an embodiment of the present disclosure.

A computing system 200 may be connected through a wired/wireless communication network or a network 10 with a separate terminal (not shown), a server 20, an integrated big data platform 30, and a big data analytics platform 40 without being limited to a particular communication protocol, transmitting and receiving various pieces of data and information.

Here, the network 10 may refer to a connecting structure that enables exchange of data and information between nodes, e.g., a server and a terminal. Examples of such network may include, but are not limited to, a 3rd Generation Partnership Project (3GPP) network, a Long Term Evolution (LTE) network, a Long Term Evolution-Advanced (LTE-A) network, a World Interoperability for Microwave Access (WIMAX) network, an Internet network, a Local Area Network (LAN) network, a Wireless LAN network, a Wide Area Network (WAN) network, a Personal Area Network (PAN) network, a Bluetooth network, a satellite broadcast network, an analog broadcast network, and a Digital Multimedia Broadcasting (DMB) network.

The server 20 may be operated on various operating systems (OSs) and may run various additional server applications or mid-tier applications including a hypertext transfer protocol (HTTP) server, a file transfer protocol (FTP) server, a common gateway interface (CGI) server, a Java server, and a database server. The server 20 may be equipped with the integrated big data platform 30 and the big data analytics platform 40. The server 20 may be clustered with another server 20′ to support parallel processing and distributed processing. The servers 20 and 20′ may be present in the same network or different networks. The other server 20′ may also be equipped with an integrated big data platform 30′ and a big data analytics platform 40′. For ease of description, the following description of the server 20, the integrated big data platform 30, and the big data analytics platform 40 may apply likewise to the server 20′, the integrated big data platform 30′, and the big data analytics platform 40′.

The integrated big data platform 30 may collect and store multiple databases or multiple pieces of data, and the big data analytics platform 40 may analyze data stored in the integrated big data platform 30 by various analysis schemes.

The multiple databases may be present at various positions. For example, the multiple databases may be resident on a non-transitory storage medium or may be located in a site far away from the server 20. Such various databases may be ones established to be able to store, update, and search for data in response to SQL or NoSQL commands or queries.

The computing system 200 may be implemented as a computer or portable terminal. The computer may include, e.g., a WEB browser-equipped personal computer (PC), desktop computer, laptop computer, tablet PC, or slate PC. Examples of the portable terminal may include portable and mobile wireless communication devices, e.g., a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, or any other various types of handheld wireless communication devices.

Although FIG. 2 illustrates an example in which the components of the computing system 200 are separate from each other, all or some of the components may alternatively be integrated or embedded into a single unit or module in the goal-oriented big data business analytics framework. Each component of FIG. 2 may be modified, replaced, or modularized depending on design choices or purposes, and a particular function of one component may be operated or performed by another component.

According to an embodiment of the present disclosure, the computing system 200 may include a processor 210, a memory 220, a user input/output sub system 230, a communication sub system 240, a display sub system 250, a storage device 260, an acceleration device 270, a media reader 280, and a computer readable storage memory 290. The computing system 200 performs goal-oriented big data business analytics.

The hardware components in the computing system 200 may be electrically or communicatively connected together via a bus.

At least one processor 210 may be configured to connect with the memory 220, the storage device 260, or the computer readable storage memory 290, and the processor 210 may run a program stored in the memory 220 or an external memory (not shown). The processor 210 may control the operation of each component of the computing system 200 by transmitting a signal or command to the component according to a program. The processor 210 may receive a signal or information from each component and perform an operation corresponding to the signal or information.

The memory 220 may be implemented as, e.g. a random access memory (RAM) or read-only memory (ROM) like the storage device 260 described below. The memory 220 may store software components that are retained in the memory 220. The software components may include an OS 222 and a code 224. The code 224 may include an application program, such as a client application, a web browser, a mid-tier application, or a relational database management system (RDBMS), and multiple executable commands and a data structure.

The user input/output sub system 230 may generate a signal in response to a user input. The user input/output sub system 230 may include, e.g., a mouse, a keyboard, a button, or a touchpad.

The communication sub system 240 may communicate with other computing devices wiredly or wirelessly connected through the network 10. The communication device 210 may be implemented in a wired/wireless communication module, a network card, or an infrared (IR) communication device. For example, the wired/wireless communication module may be implemented as a power line communication (PLC) device, a dial-up communication device, a cable home (MoCA) device, an Ethernet device, an IEEE 1294 device, an integrated wired home network and RS-485 controller. The wireless communication module may be implemented by, e.g., wireless LAN (WLAN), Bluetooth, HDR, WPAN, UWB, ZigBee, Impulse Radio, 60 GHz WPAN, Binary-CDMA, wireless USB technology or wireless HDMI technology.

The display sub system 250 may output data that is generated as the computing system 200 operates. The display sub system 250 may include, e.g., a display or a printer. The display sub system 250 may include a screen, display, or monitor for displaying multiple pieces of information and multiple buttons for entry of numerals, characters, or symbols by interworking with the user input/output sub system 230. The screen of the display sub system 250 may receive touch-based inputs depending on the model.

The storage device 260 may be used to store or transmit desired information (including a code). The storage device 260 may be accessed by the processor 210. The storage device 260 may include, e.g., a NAND flash memory, such as a compact flash card, a secure digital (SD) card, a MemoryStick™, a solid state drive (SSD), or a micro SD card, a magnetic computer storage device, such as a hard disk drive (HDD), and an optical disk drive, such as a CD-ROM or DVD-ROM.

The acceleration device 270 may include, e.g., a digital signal processor (DSP) or a special-purpose processor.

The media reader 280 may be connected with the computer readable storage memory 290 that is a fixed, integrated, or removable storage device (or medium) for temporarily or permanently retaining computer readable information. The computer readable storage memory 290 may also be used to store or transmit desired information (including a code). The computer readable storage memory 290 may be accessed by the processor 210.

According to an embodiment of the present disclosure, at least one processor 210 may be configured to run multiple commands or run a stored program. The commands and program may be stored in the memory 220 or another memory separated from the memory 220. The commands or the program may be executed by the processor 210 to perform predetermined functions or operations or to enable the processor 210 to perform predetermined functions or operations.

According to an embodiment of the present disclosure, the multiple commands may include a command for setting up each of, at least, a business goal, a business process goal which is a goal for an activity or task related to a process for achieving the business goal, and a numerical goal (e.g., a performance goal) for the business goal or the business process goal, a command for generating a hypothesized solution under the hypothesis that a first phenomenon related to the activity or task corresponds to a solution, which is a phenomenon positively contributing to the achievement of at least any one of the business goal, the business process goal, and an performance goal, a command for determining that the hypothesized solution is a validated solution when the hypothesized solution is a phenomenon making a positive contribution based on a result of analysis of business goal, and a command for modifying the activity or task based on the validated solution. The multiple commands may further include a command for comparing the advantages and disadvantages of a plurality of alternatives according to a label propagation algorithm to select a final alternative and a command for assigning the modified activity or task to a conducting agent.

The commands may be used to hypothesize a solution related to a goal set in a business context, validate the hypothesized solution, and enhance or modify a business process (including the goal) through the validated solution by the computing system 200 or the processor 210.

According to an embodiment of the present disclosure, the multiple commands may include a command for setting up each of a business goal, a business process goal which is a goal for an activity or task related to a process for achieving the business goal, and a numerical goal for the business goal or the business process goal, a command for modeling a hypothesized problem under the hypothesis that a first phenomenon related to the activity or task corresponds to a problem, which is a phenomenon negatively contributing to the achievement of at least any one of the business goal, the business process goal, and an performance goal, a command for determining that the hypothesized problem is a validated problem when the hypothesized problem is a phenomenon making a negative contribution based on a result of analysis of big data, a command for modeling a hypothesized solution under the hypothesis that a second phenomenon related to the activity or task corresponds to a solution, which is a phenomenon positively contributing to the achievement of at least any one of the business goal, the business process goal, and the performance goal or capable of addressing the validated problem, a command for determining that the hypothesized solution is a validated solution when the hypothesized solution makes a positive contribution based on a result of analysis of business goal, and a command for modifying the activity or task based on the validated solution. The multiple commands may further include a command for comparing the advantages and disadvantages of a plurality of alternatives according to a label propagation algorithm to select a final alternative and a command for assigning the modified activity or task to a conducting agent.

The commands may be used to hypothesize a problem and solution related to a goal set in a business context, validate the hypothesized problem and solution, and enhance or modify a business process (including the goal) through the validated problem and solution by the computing system 200 or the processor 210. The validated problem may also be considered in the process of hypothesizing and validating the solution, and thus, the reliability of the process can be increased. According to an embodiment of the present disclosure, the computing system 200 may include modules or components that perform all or some of individual operations corresponding to the above-described commands, respectively.

According to an embodiment of the present disclosure, the computing system 200 may further include a user interface (UI) configured to visualize data corresponding to a result of execution of at least one of the multiple commands and display the visualized data. The UI may be connected with the above-described user input/output sub system 230 and the display sub system 250.

The UI may use a business context integrated language that is configured based on a soft-goal interdependence graph (SIG), problem interdependence graph (PIG), and business process model and notation (BPMN) in the non-functional requirement (NFR) framework.

For reference, the business context integrated language may be used to model big data 30 and the big data analytics platform 40 or a big query configured to analyze big data. A relationship between an object to be modeled and the components of the business context integrated language is shown in FIG. 1.

The PIG is a variation to the SIG of NFR framework. A non-functional soft-goal in the NFR framework may be represented in a form, such as “Type [Topic]” (e.g., “effective [clearance pricing decision]”). Throughout the specification, the hypothesized problem and validated problem, and the hypothesized solution and validated solution may be represented in the same form, “Type [Topic].” Here, the item Type denotes the non-functional attribute value, the item Topic denotes the functional attribute value corresponding to the item Type, and the item Topic corresponds to the element constituting the business process notated by the BPMN.

The UI is described below in greater detail in connection with an example related to clearance pricing decision in clothing business.

The computing system described above may choose the optimal one among multiple alternatives related to the achievement of a goal in a business context and apply a result of analysis of big data in designing a business, increasing reliability and accuracy while creating new value.

<Computer Executed Process by Goal-Oriented Big Data Business Analytics Framework>

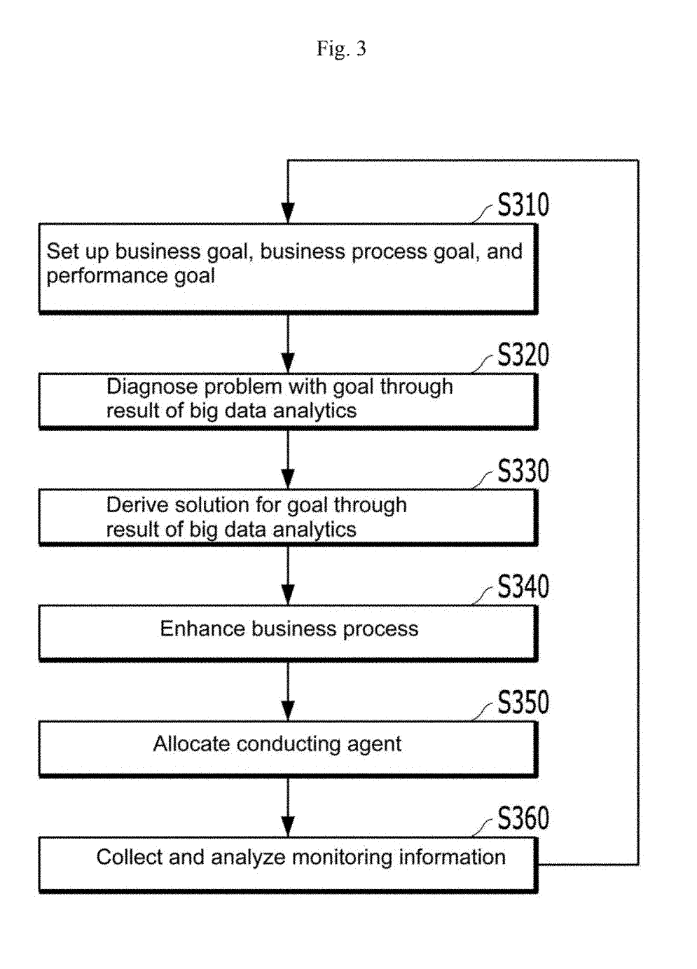

Embodiments of the present disclosure are described below with reference to FIG. 3. FIG. 3 is a flowchart illustrating a process performed by a computing system performing goal-oriented big data business analytics according to an embodiment of the present disclosure. The computing system is not limited to a particular configuration. However, the description is made below in connection with the configuration of FIG. 2.

The computing system 200 or at least one processor 210 sets up a goal that it intends to achieve in a business context in step S310.

According to an embodiment of the present disclosure, the computing system 200 or the processor 210 sets up each of a business goal, a business process goal which is a goal for an activity or task related to a process for achieving the business goal, and an performance goal for the business goal or the business process goal in step S310.

According to an embodiment of the present disclosure, the business goal, the business process goal, and the performance goal each may be set up dependent upon stakeholders in step S310. The set-up step S310 may reflect an interview with the stakeholders.

According to an embodiment of the present disclosure, a business goal-business process map indicating whether some activity or task positively or negatively contributes to the achievement of the business goal may be configured by analyzing a correlation between the performance goal and the business process (which is the activity or task related to the process for achieving the business goal) using big data. How the business process influences the business goal may be figured out from an overall perspective by the business goal-business process map.

The computing system 200 or the at least one processor 210 performing goal-oriented big data business analytics may perform a big data analytics and diagnoses problems with the goal set up in step S310 through a result of the big data analytics (S320). The big data analytics may be done using a big query or the big data analytics platform 40, or in some cases, the big data analytics may be performed considering problems discovered from the business goal-business process map.

According to an embodiment of the present disclosure, step S330 may immediately be performed while skipping step S320.

According to an embodiment of the present disclosure, the computing system 200 or the processor 210 explicitly models, in step S320, a hypothesized problem under the hypothesis that a first phenomenon corresponds to a problem, which is a phenomenon negatively contributing to the achievement of at least any one of the business goal, the business process goal, and the performance goal set up in step S310. The first phenomenon may be a phenomenon related to an activity or task related to the process for achieving the business goal.

In step S320, the computing system 200 or the processor 210 determines that the hypothesized problem is a validated problem when the hypothesized problem is a phenomenon making a negative contribution based on a result of analysis of big data using a first big query or the big data analytics platform 40. The first big query may be a medium connecting conceptual modeling with big data. The first big query may be configured in at least one language of SQL and NoSQL. The first big query may be used to query about multiple databases stored in the integrated big data platform 30.

In other words, a result of analysis of big data or a result of big query may be used as evidence for validating the hypothesized problem. Various query languages and queries may be used in a goal-oriented approaching process, and data in various databases may selectively be considered as a target for analysis. The analysis method may be any one or a combination of various known methods but is not limited thereto.

An interview with a stakeholder may be reflected in the process of diagnosing the business-related problem.

Next, the computing system 200 or the at least one processor 210 may perform a big data analytics and derive a solution for the goal set up in step S310 through a result of analysis of big data (S330). The big data analytics may be performed using the big query or the big data analytics platform 40.

According to an embodiment of the present disclosure, the computing system 200 or the processor 210 explicitly models, in step S330, a hypothesized solution under the hypothesis that a predetermined phenomenon corresponds to a solution, which is a phenomenon positively contributing to the achievement of at least any one of the business goal, the business process goal, and the performance goal set up in step S310. The predetermined phenomenon may be a phenomenon related to an activity or task related to the process for achieving the business goal.

In step S330, the computing system 200 or the processor 210 determines that the hypothesized solution is a validated solution when the hypothesized solution is a phenomenon making a positive contribution based on a result of analysis of big data using a first big query or the big data analytics platform 40. The predetermined big query may be a medium connecting conceptual modeling with big data. The first big query may be configured in at least one language of SQL and NoSQL. The first big query may be used to query about multiple databases stored in the integrated big data platform 30.

According to an embodiment of the present disclosure, the computing system 200 or the processor 210 explicitly models, in step S330, a hypothesized solution under the hypothesis that a second phenomenon corresponds to a solution, which is a phenomenon positively contributing to the achievement of at least any one of the business goal, the business process goal, and the performance goal set up in step S310 or a phenomenon capable of addressing the validated problem in step S320. The second phenomenon may be a phenomenon related to an activity or task related to the process for achieving the business goal.

In step S330, the computing system 200 or the processor 210 determines that the hypothesized problem is a validated problem when the hypothesized problem is a phenomenon making a negative contribution based on a result of analysis of big data using a second big query or the big data analytics platform 40. The second big query may be a medium connecting conceptual modeling with big data. The first big query may be configured in at least one language of SQL and NoSQL. The second big query may be used to query about multiple databases stored in the integrated big data platform 30.

In other words, a result of analysis of big data or a result of big query may be used as evidence for validating the hypothesized solution. Various query languages and queries may be used in a goal-oriented approaching process, and data in various databases may selectively be considered as a target for analysis. The analysis method may be any one or a combination of various known methods but is not limited thereto.

Next, the computing system 200 or at least one processor 210 may perform a process for enhancing or modifying the business process to achieve the goal set up in step S310 (S340).

According to an embodiment of the present disclosure, the computing system 200 or the processor 210 may, in step S340, modify or re-generate an activity or task related to the process for achieving the business goal based on the validated solution in step S330.

In other words, the goal-oriented big data business analytics is performed through three steps S310, S330, and S340, according to an embodiment of the present disclosure. Alternatively, the goal-oriented big data business analytics may be performed through four steps S310 to S340.

According to an embodiment of the present disclosure, the computing system 200 or the processor 210 may, in step S340, model a plurality of business process alternatives by combining and applying a plurality of validated solutions, compare the advantages and disadvantages of the plurality of business process alternatives by a label propagation algorithm, and select a final business process alternative.

The label propagation algorithm, which is a concept applied from the NFR framework, refers to an algorithm for assessing how a lower goal influences a higher goal.

The influence on the higher goal is varied depending on whether to make a closed world assumption under which knowledge signifying a positive or negative influence is the overall knowledge for a corresponding domain or an open world assumption under which knowledge signifying a positive or negative influence differs from the overall knowledge of a corresponding domain.

In the case of knowledge indicating a negative influence, when a lower goal has a relationship of “MAKE” with a higher goal under the closed world assumption (e.g., a positive contribution), and the lower is “Denied,” the higher goal is “Denied.” In the same context under the open world assumption, however, the higher goal is “Undecided.” When the lower goal has a relationship of “HURT” with the higher goal (e.g., a negative contribution), and the lower goal is “Denied” under the closed world assumption, the higher goal is “Weakly Satisfied.” In the same context under the open world assumption, however, the higher goal is “Undecided.”

In the case of knowledge indicating a positive influence, when the lower goal has a relationship of “MAKE” with the higher goal in both the closed world assumption and the open world assumption, and the lower goal is “Satisfied,” the higher goal is “Satisfied” as well. When the lower goal has a relationship of “HURT” with the higher goal, and the lower goal is “Satisfied,” the higher goal is “Denied.”

A goal may be labeled or referred to as ‘satisfied,’ ‘weakly satisfied,’ ‘weakly denied,’ ‘denied,’ or ‘conflicts’ depending on the influence or the degree of contribution.

According to the present disclosure, the label propagation algorithm may recognize all of the business goal, the performance goal, the business process goal, and the business process as goals. Thus, the label propagation algorithm of the NFR framework may be followed or a propagation algorithm in the BPMN element may be added. The BPMN element may be expressed as a relationship between whole and part. In achieving the business process goal, parts of the element have a relationship of AND or OR.

The label propagation algorithm of the present disclosure, unlike the conventional label propagation algorithm, determines a relationship based on a result of analysis of big data, thus bringing about a more reliable inference outcome. Further, the label propagation algorithm of the present disclosure may easily figure out which part of the BPMN element is a problem and help to modify the part.

As such, the label propagation algorithm may enable a determination as to how much each business process alternative influences the achievement of the business goal. The degree of the influence may be represented as any one of “fully denied,” “weakly denied,” “conflict,” “weakly satisfied,” and “fully satisfied.” The same concept may apply to the following label propagation algorithm, and no detailed description thereof is given below.

Next, in step S350, the computing system 200 or at least one processor 210 performing goal-oriented big data business analytics assigns or allocates the business process, which is enhanced or modified in step 340, to a conducting agent.

According to an embodiment of the present disclosure, the computing system 200 or the processor 210 assigns an activity or task modified or regenerated to the conducting agent in step 350. In this case, the conducting agent may be a people agent, a to-be-developed system agent, or other system agent.

When the particular activity or task is assigned to a person or another system, the particular activity or task becomes an expectation, and when the particular activity or task is assigned to a to-be-developed system, the particular activity or task becomes a high abstraction level requirement of the software system.

According to an embodiment of the present disclosure, in step S350, the computing system 200 or the processor 210 may compare the advantages and disadvantages of a plurality of conducting agents to select a final conducting agent according to the label propagation algorithm and may assign the activity or task modified or regenerated to the final conducting agent selected.

The label propagation algorithm may enable a determination as to how much each conducting agent influences the achievement of the business goal. The degree of the influence may be represented as any one of “fully denied,” “weakly denied,” “conflict,” “weakly satisfied,” and “fully satisfied.”

Subsequently, the computing system 200 or at least one processor 210 performing goal-oriented big data business analytics monitors a performance process and context as per the business process enhanced or modified in step S350 and collect and analyze monitoring information (S360).

According to an embodiment of the present disclosure, in step S360, the computing system 200 or the processor 210 collects and analyzes monitoring information by monitoring a performance process as per the activity or task modified by the conducting agent. In this case, the computing system 200 or the processor 210 may monitor, in real-time, the performance process and context as per the enhanced or modified business process using a data visualizer and reporting tool in step S360.

The computing system 200 or the at least one processor 210 also resets at least any one of the business goal, the business process goal, and the performance goal of step S310 based on the monitoring information collected and analyzed.

The computing system 200 performing goal-oriented big data business analytics provides a user interface configured to visualize data corresponding to a result of performing at least one of steps S310 to S360 and display the visualized data.

The UI may use a business context integrated language that is configured based on a soft-goal interdependence graph (SIG), problem interdependence graph (PIG), and business process model and notation (BPMN) in the non-functional requirement (NFR) framework.

The business context integrated language may model big data and the big data analytics platform 40 or a big query configured to analyze big data. The corresponding language may model major concepts that are critically treated throughout the specification, such as business goal, business process goal, performance goal (including the KPI), business process, business-related problem and solution, conducting agent, or stakeholder, and the language may also model the business goal-business process map described above in connection with step S310.

As set forth above, the hypothesized problem and validated problem, and the hypothesized solution and validated solution are expressed in the form of “Type [Topic]” where the item “Type” indicates the non-functional attribute value. The item “Topic” indicates the functional attribute value corresponding to the item “Type” and may correspond to the elements constituting the business process notated by BPMN.

In the NFR framework, for example, the item “Type” may more specifically be refined using a pattern catalog, and the item “Topic” may more specifically be refined with the elements constituting the business process.

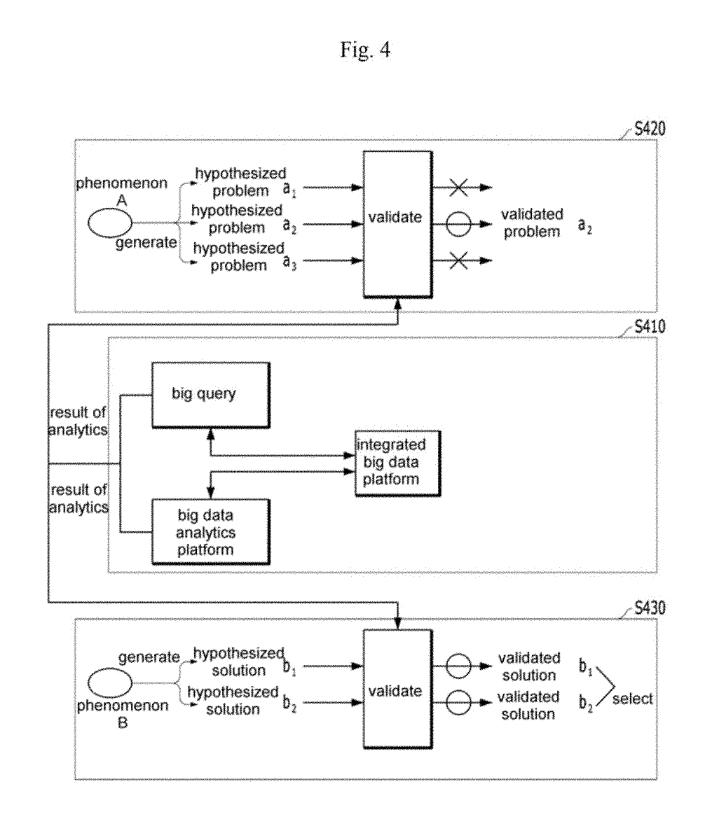

The computer executed process is described below in greater detail with reference to FIG. 4. FIG. 4 is a view illustrating a process in which a computing system performing goal-oriented big data business analytics validates problems and solutions based on a big query or big data analytics result according to an embodiment of the present disclosure.

Steps S410 to S430 described below may be ones for describing steps S320 and S330 of FIG. 3 in further detail.

Step S410 illustrates part of the goal-oriented big data business analytics framework.

In step S410, a big data analytics platform, or a dedicated processor for analyzing big data, analyzes multiple pieces of data collected and stored in an integrated big data platform on its own or using a big query (or query). According to an embodiment of the present disclosure, the dedicated processor for analyzing big data may be disposed inside the computing system 200, or the dedicated processor may be disposed within the big data analytics platform and connected with the computing system 200).

A target for analysis may selectively be determined given a relationship with the business goal, business process goal, performance goal (including the KPI), or business-related problem and solution.

The target for analysis or big data may be analyzed by various machine learning algorithms, and a result of analysis may include an analysis and prediction as to a correlation between the pieces of data. For example, the big data analytics platform may be implemented by Spark which is a cluster-computing platform. The prediction in the result of analysis may be a result of predictive analysis of the target for analysis through the prediction algorithm provided by Spark. There may be various machine learning algorithms and prediction algorithms. An algorithm to be put to use may be chosen by comparing the advantages and disadvantages of each algorithm depending on various considerations, e.g., accuracy and performance, and purposes.

In step S410, there may be a plurality of big queries. According to an embodiment of the present disclosure, the computing system 200 may compare the advantages and disadvantages of the plurality of big queries to choose a final big query according to a label propagation algorithm.

The label propagation algorithm may enable a determination as to how much each big query influences the achievement of the business goal. The degree of the influence may be represented as any one of“fully denied,” “weakly denied,” “conflict,” “weakly satisfied,” and “fully satisfied.”

Here, the big query may be configured by at least any one language of SQL and NoSQL and may be used to query about multiple databases stored in the integrated big data platform.

The big data analytics platform may be implemented by Spark which is a clustered computing platform. A query may be carried out in the form of SQL through Spark SQL regardless of which one of SQL or NoSQL database has been used to establish the database to be analyzed.

Step S420 illustrates the processes of validating a hypothesized problem and determining that the hypothesized problem is a validated problem, which can be performed by the computing system 200 according to an embodiment of the present disclosure.

As described above, step S430 may be performed with step S420 omitted according to an embodiment of the present disclosure. Alternatively, steps S420 and S430 both may be performed.

In step S420, there may be a plurality of hypothesized problems. The plurality of problems may be modeled by a scheme as described below, and some of the plurality of problems may be selected.

According to an embodiment of the present disclosure, multiple hypothesized problems may be modeled for a predetermined phenomenon by negating the performance goal for the business process goal or the business goal.

According to an embodiment of the present disclosure, the activity or task related to the process for achieving the business goal may include a plurality of sub tasks or sub activities which are configured in a hierarchical structure similar to that of an onion.

The computing system 200 may model a core problem or root-cause problem of the multiple hypothesized problems for the predetermined phenomenon using at least one of a top-down scheme in which the sub tasks or sub activities are reviewed from the outermost sub task or sub activity to the innermost sub task or sub activity, a bottom-up scheme in which the sub tasks or sub activities are reviewed from the innermost sub task or sub activity to the outermost sub task or sub activity, and a hybrid scheme which is a combination of the top-down scheme and the bottom-up scheme.

In step S420, a plurality of problems may be present after the validation process. According to an embodiment of the present disclosure, the computing system 200 may compare the advantages and disadvantages of the plurality of validated problems to choose a final validated problem according to a label propagation algorithm.

The label propagation algorithm may enable a determination as to how much each validated problem influences the achievement of the business goal. The degree of the influence may be represented as any one of “fully denied,” “weakly denied,” “conflict,” “weakly satisfied,” and “fully satisfied.”

For example, in step S420, the computing system 200) may model hypothesized problems a1 to a3 under the hypothesis that phenomenon A is a problem which is a phenomenon negatively contributing to the achievement of at least any one of the business goal, the business process goal, and the performance goal as illustrated in FIG. 4. Of the hypothesized problems a1 to a3, a core hypothesized problem a2 may be selected or modeled.

As illustrated in FIG. 4, step S420 may determine that the hypothesized problem a2 is a validated problem a2 using a result, by step S410, of goal-oriented big data business analytics using big data. The remaining hypothesized problems a1 and a2 may be excluded from consideration in subsequent steps.

Step S430 illustrates the processes of validating a hypothesized solution and determining that the hypothesized solution is a validated solution, which can be performed by the computing system 200 according to an embodiment of the present disclosure.

In step S430, there may be a plurality of hypothesized solutions. The plurality of solutions may be modeled by a scheme as described below, and some of the plurality of solutions may be selected.

According to an embodiment of the present disclosure, multiple hypothesized solutions may be modeled for a predetermined phenomenon by negating the problems of step S420 or by finding a means to achieve the performance goal for the business process goal or the business goal.

Generally, a problem and a solution have a negative relationship. However, an analysis of the correlation between multiple problems and multiple solutions reveals that there may be problems with a positive relationship and solutions with a negative relationship. Accordingly, such correlation may be needed to be made in advance.

The computing system 200 may model a core hypothesized solution of multiple hypothesized solutions for a predetermined phenomenon using at least one of the top-down scheme, the bottom-up scheme, and the hybrid scheme.

The top-down scheme, the bottom-up scheme, and the hybrid scheme have been described above and are not repeated described below.

In step S430, a plurality of solutions may be present after the validation process. According to an embodiment of the present disclosure, the computing system 200 may compare the advantages and disadvantages of the plurality of validated solutions to choose a final validated solution according to a label propagation algorithm.

The label propagation algorithm may enable a determination as to how much each validated solution influences the achievement of the business goal. The degree of the influence may be represented as any one of “fully denied,” “weakly denied,” “conflict,” “weakly satisfied,” and “fully satisfied.”

For example, in step S430, the computing system 200 may model hypothesized solutions b1 and b2 under the hypothesis that phenomenon B is a solution which is a phenomenon positively contributing to the achievement of at least any one of the business goal, the business process goal, and the performance goal or a phenomenon capable of addressing the validated problem in step S420 as illustrated in FIG. 4. Of the hypothesized solutions b1 and b2, a core hypothesized solution b1 may be selected or modeled.

In step S430, the computing system 200 may determine that both the hypothesized solutions b1 and b2 are validated solutions b1 and b2 using a result of the goal-oriented big data business analytics of step S410 as illustrated in FIG. 4. Any one of the validated solutions b1 and b2 may be selected as the final validated solution.

Thereafter, the computing system 200 may enhance or modify the business process initially set before step S410 based on at least one validated solution, as described above in connection with FIG. 3. Here, since the validated solution is expressed in the form of Type [Topic], and the item “Topic” corresponds to the elements constituting the business process written by BPMN, the computing system 200 may modify the elements of the business process by referring to the item “Topic.”

As such, the business process may rationally and properly be adjusted and modified for the goal to be achieved in a business context by using the result of data-oriented approach and goal-oriented approach-based big data analytics.

<Goal-Oriented Big Data Business Analytics Framework>

The computing system and the computer executed method according to the present disclosure, as described above, may be implemented into a goal-oriented big data business analytics framework or system which is called IRIS. The framework is now described below.

The goal-oriented big data business analytics framework may support descriptive, predictive, and prescriptive analysis and may deal with 5-V (Value, Volume, Velocity, Variety, and Veracity) properties of big data.

For example, the Value property may be treated by diagnosing problems by associating big data with the business goal, business process goal, performance goal, or business process and using the big data as evidence materials to propose solutions.

The Volume property may be treated by utilizing databases which can support clustering of commodity hardware.

The Velocity property may be treated by quickly analyzing big data using various in-memory processing techniques in a distributed cluster-computing environment, and the Variety property may be treated by indiscriminately connecting databases supportive of SQL and NoSQL by adopting Spark.

The Veracity property may be treated by accruing data per business context by repeatedly driving the system.

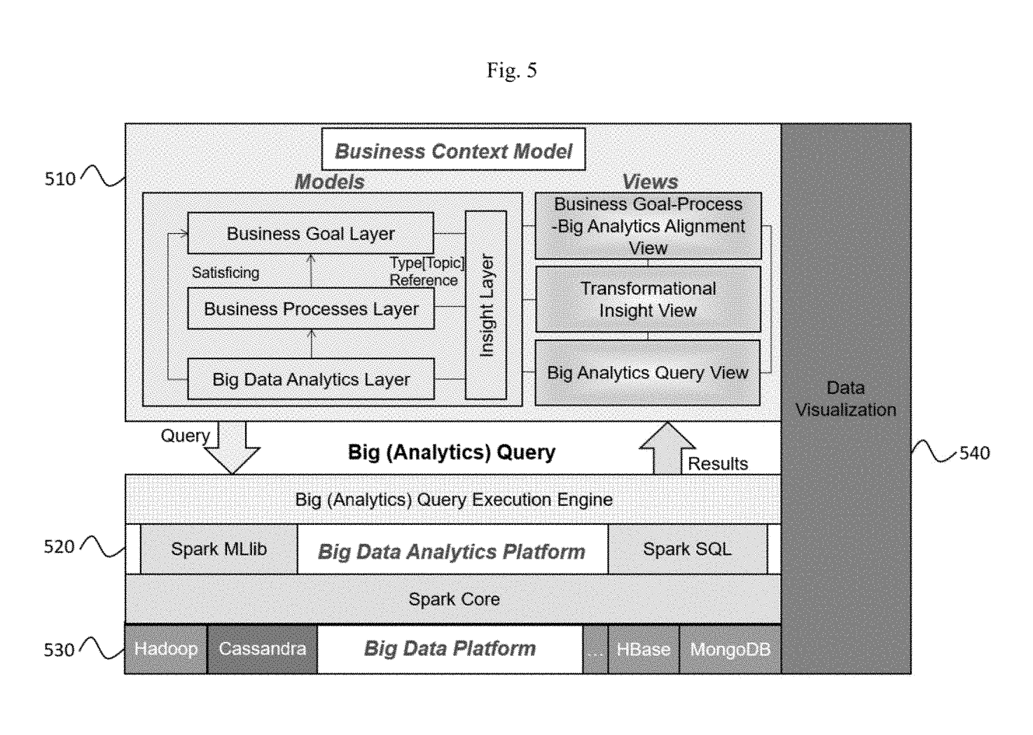

FIG. 5 is a view illustrating an architecture for a tool supporting a goal-oriented big data business analytics framework or system according to an embodiment of the present disclosure. Referring to FIG. 5, the architecture may include a business context modeler 510, a big data analytics platform 520, an integrated big data platform 530, and a data visualizer 540.

The business context modeler 510 is a component supporting business context modeling and capable of modeling and processing concepts in a business context, such as business goal, business process, business process goal, business-related problem and solution, stakeholder, or conducting agent. The business context modeler 510 may also include big data-related concepts, such as big query or big data.

The business context modeler 510 may generate, modify, and delete components of business context modeling using a business context integrated language on eclipse modeling framework (EMF), and the business context modeler 510 may visualize and display modeling elements on a screen of a display using Sirius.

The business context modeler 510 may be connected with the big data analytics platform 520 through a big query, and the big data analytics platform 520 may be connected with the integrated big data platform 530 through a connector. The big query may support a query about data in the form of SQL irrespective of the type of the integrated big data platform 530 which is positioned at a lower level. For example, in the case of Spark, a query about data may be carried out in the form of SQL through Spark SQL.

The big data analytics platform 520 and the integrated big data platform 530 may be components for handling big data.

The big data analytics platform 520 analyzes data of the integrated big data platform 530 and validates, based on the results of analysis, hypotheses that are made for problems and solutions. A query and a big query may be configured for analysis of big data.

The big data analytics platform 520 may be implemented using Spark. By in-memory use of resilient distributed dataset (RDD), Spark may process data more quickly than MapReduce which processes data using two functions, Map and Reduce, on hard disk. The big data analytics platform 520 may rapidly obtain a result of analysis using a distributed cluster-computing environment, and the big data analytics platform 520 may also obtain a prediction result through a machine learning library supported by Spark.

The integrated big data platform 530 collects and stores multiple pieces of data.

The integrated big data platform 530 may include a NoSQL database, such as Cassandra or Mongo database, a conventional type of SQL-based relational database management system (RDBMS), and an HDFS-supported file system, such as Hadoop.

The data visualizer 540 may be integrated into Business Intelligence and Reporting Tools (BIRT) which is a reporting tool for big data. BIRT enables technical analysis and visualization on big data using a big query for each database platform.

Such architecture and supporting tools may contribute to increasing reliability in designing a business context.

<Example of Application to Clothing Business and Car Sales Business>

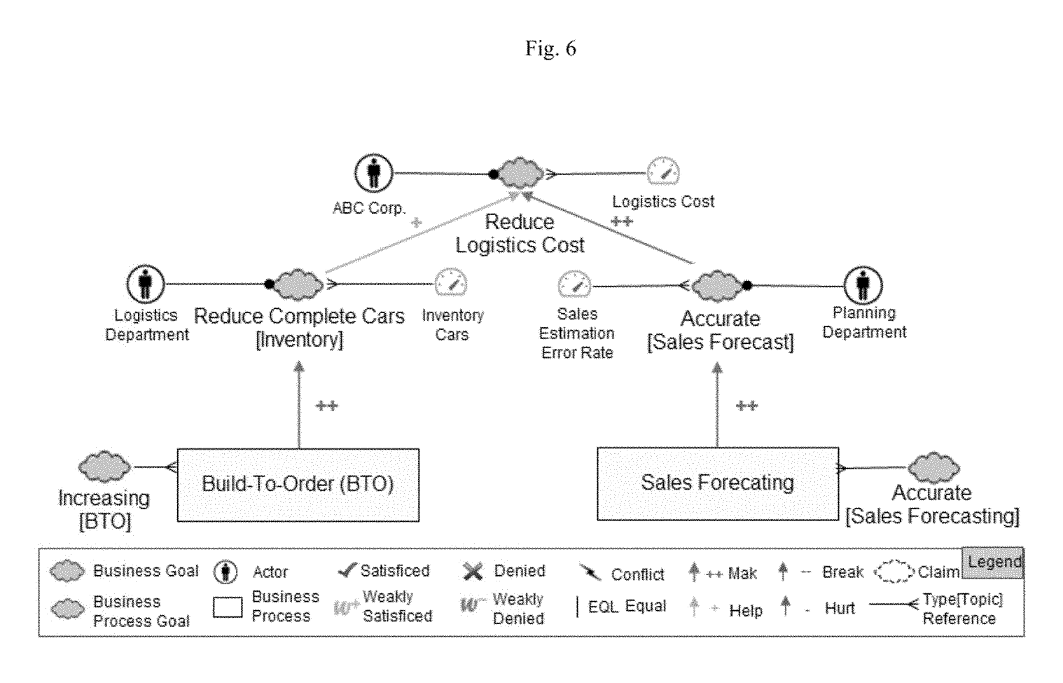

FIGS. 6 to 12b illustrate examples of applying the architecture and supporting tools described above to a clothing business and a car sales business.

First, a business goal, a business process goal, and a performance goal are set up for the clothing business. A stakeholder for the clothing business may additionally be set up.

FIG. 6 is a view illustrating an example of a business goal-business process map related to a car sales business according to an embodiment of the present disclosure.

When the goals for the clothing business are set up, a business goal-business process map as shown in FIG. 6 may be configured. The map so configured presents an overall view as to whether a predetermined business process positively or negatively contributes to the achievement of the business goal or business process goal using analysis of a correlation between the performance goal for the business goal and the performance goal for the business process goal. The correlation may be analyzed using a machine learning library that is provided by Spark. How the business process influences the business goal may be figured out by the map.

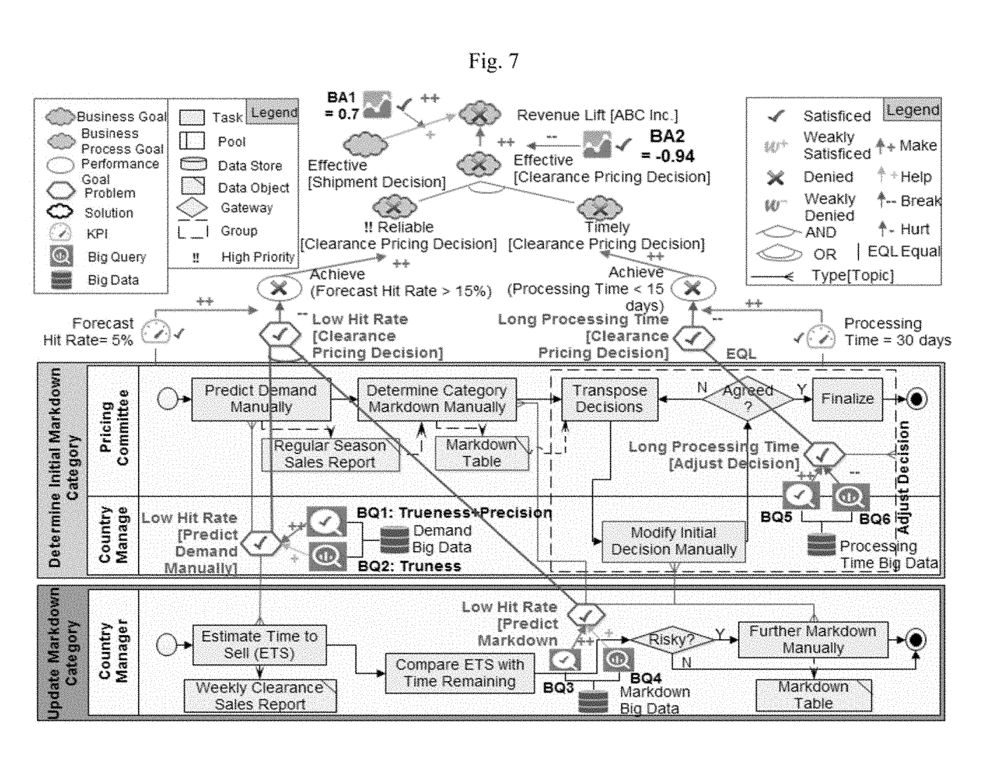

FIG. 7 is a view illustrating an example of a process for setting up a goal related to a clothing business and validating problems with the goal according to an embodiment of the present disclosure.

For example, the business goal is set to “Revenue Lift [Zara Inc.],” and the business process goal is set to “Effective [Clearance Pricing Decision]”. Specific lower business process goals are set to “Reliable [Clearance Pricing Decision]” and “Timeliness (Clearance Pricing Decision”. For example, the performance goal is to “Achieve (Forecast Hit Rate>25%)” and “Achieve (Processing Time<15 days)”. For example, the stakeholder is set to “Zara Inc.” and “Planning Department”.

Next, a process for modeling a hypothesized problem and determining a validated problem is performed.

A hypothesized problem for a phenomenon observed in the clothing business may be generated through a numerical goal. For example, a hypothesized problem is generated under the hypothesis that “Not Achieved (Achieve (Forecast Hit Rate>25%))” corresponds to a problem which is a phenomenon making a negative contribution.

As the hypothesized problem, “Low Hit Rate [Clearance Sale]” and “Low Hit Rate [Predict Demand Manually]” and “Low Hit Rate [Predict Markdown Manually]” which are fundamental causes for “Low Hit Rate [Clearance Sale]” are generated. As the hypothesized problem, “Long Processing Time [Clearance Sale]” and “Long Processing Time [Adjust Decision]” which is a fundamental cause for “Long Processing Time [Clearance Sale]” are generated.

When the hypothesized problem is a phenomenon making a negative contribution based on a result of analysis of big data using the big query, the hypothesized problem is determined to be a validated problem. The analysis of big data may be performed on a big data analytics platform.

As per ISO 5725, “trueness” indicates the degree to which a predicted value approaches an actual value, and “precision” indicates the degree of difference between predicted values. In other word, “trueness” may represent current predicted demand for actual demand while “precision” may represent current predicted demand for a mean of trueness data accrued.

[symbol]

BQ1: /* trueness + precision of demand predication */ [symbol]
BQ2: /* only trueness of demand prediction */

/* trueness of demand prediction */
SELECT a.category, (prdt_dmd − real_dmd) as trueness
FROM ( SELECT category, prdt_dmd

FROM markdown_list
WHERE sales_year=2011) a,

( SELECT category, sum(sales_count) AS real_dmd

FROM sales_records
WHERE sale_type=‘c’
AND sales_month >= 7 AND sales_month <= 10
AND sales_year = 2011
GROUP BY category) b

WHERE a.category = b.category:
/* precision of demand prediction */
SELECT a.category. avg(prdt_dmd − real_dmd) as prescision
FROM ( SELECT category, sales_year, prdt_dmd

FROM markdown_list ) a,

```
  ( SELECT category, sales_year, sum(sales_count) |AS
  real_dmd
```

FROM sales_records
WHERE sale_type=‘c’
GROUP BY category, sales_year) b

WHERE a.category = b.category AND a.sales_year = b.sales_year
GPOUP BY a.category:

The first big query (BQ1) and the second big query (BQ2) are used to validate “Low Hit Rate [Predict Demand Manually].” The first big query is a query considering both “trueness” and “precision,” and the second big query is a query considering “trueness” alone. The big query is created in an SQL format. Given a relationship with, e.g., the numerical goal, the proper of the first big query and the second big query may be chosen to validate the hypothesized problem. As an example, the first big query is chosen.

[symbol]

BQ3: /* trueness + precision of markdown prediction */ [symbol]
BQ4: /* only trueness of markdown prediction */ [symbol]
BQ5: /* each task processing time + communication time for a

business process */

[symbol]

BQ6: /* the processing time of the whole process of determine

initial markdown category */

The third big query (BQ3) and the fourth big query (BQ4) are used to validate “Low Hit Rate [Predict Markdown Manually],” and the fifth big query (BQ5) and the sixth big query (BQ6) are used to validate “Long Processing Time [Adjust Decision].” For example, the third big query and the fifth big query are chosen.

Next, a process for modeling a hypothesized solution and determining a validated solution is performed. This process may be performed similar to the process for modeling a hypothesized problem and determining a hypothesized problem.

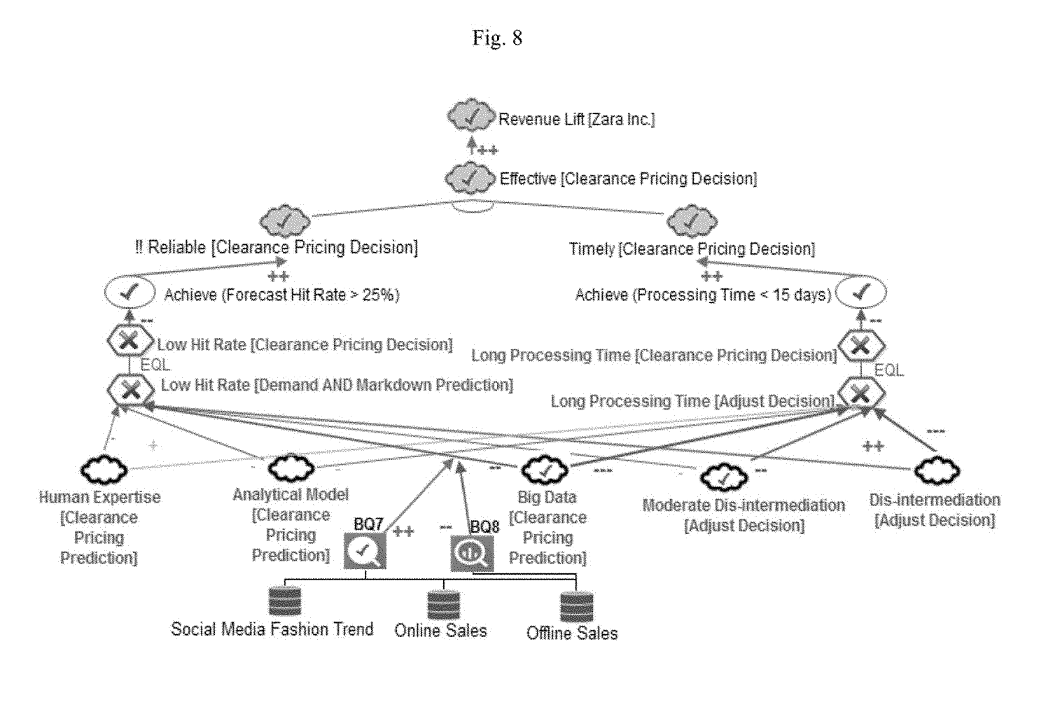

FIG. 8 is a view illustrating a process for validating a solution for a goal related to a clothing business according to an embodiment of the present disclosure.

As a hypothesized solution for a phenomenon observed in the clothing business, “Human Expertise [Clearance Pricing Prediction]”, “Analytical Model [Clearance Pricing Prediction],” and “Big Data [Clearance Pricing Prediction]” are generated.

When the hypothesized solution is a phenomenon making a positive contribution based on a result of analysis of big data using the big query, the hypothesized solution is determined to be a validated solution. The analysis of big data may be performed on a big data analytics platform.

[symbol]

BQ7: /* clearance pricing prediction by big data: social media
fashion trend + online & offline sales */ [symbol]
BQ8: /*clearance pricing prediction by big data: offline sales */

The seventh big query (BQ7) and the eighth big query (BQ8) are used to validate “Big Data [Clearance Pricing Prediction].” The seventh big query is a query considering both the “social media fashion trend” data and the “online & offline sales” data, and the eighth big query is a query considering the “offline sales” data alone. The more appropriate one among the seventh big query and the eighth big query may be chosen to validate the hypothesized solution. For example, the seventh big query may be chosen which may consider data in more various points of view.

Thereafter, the business process related to the clothing business is enhanced and modified.

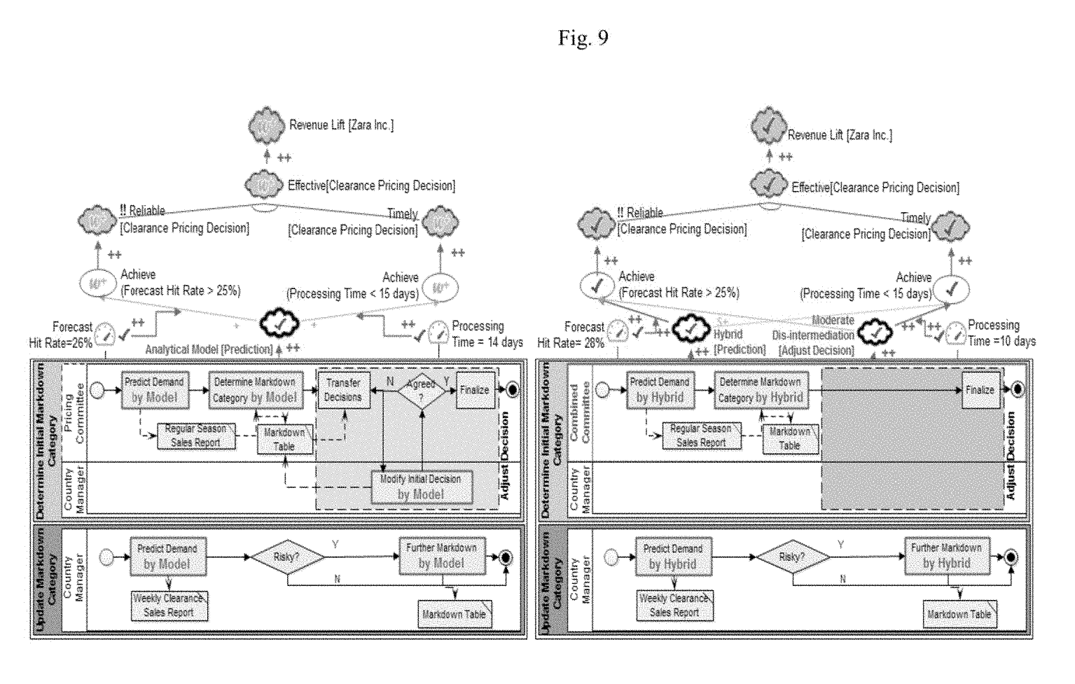

FIG. 9 is a view illustrating examples of two alternative processes for modifying a business process related to a clothing business according to an embodiment of the present disclosure.

The left-hand portion of FIG. 9 indicates results obtained by modifying the business process by applying only the validated solution “Analytical Model [Clearance Pricing Prediction],” and the right-hand portion indicates results obtained by modifying the business process by applying both the validated solutions “Big Data [Clearance Pricing Prediction]” and “Moderate Disintermediation [Adjust Decision].”

Applying two validated solutions may present a higher likelihood of achieving a business goal and business process goal than applying only one validated solution.

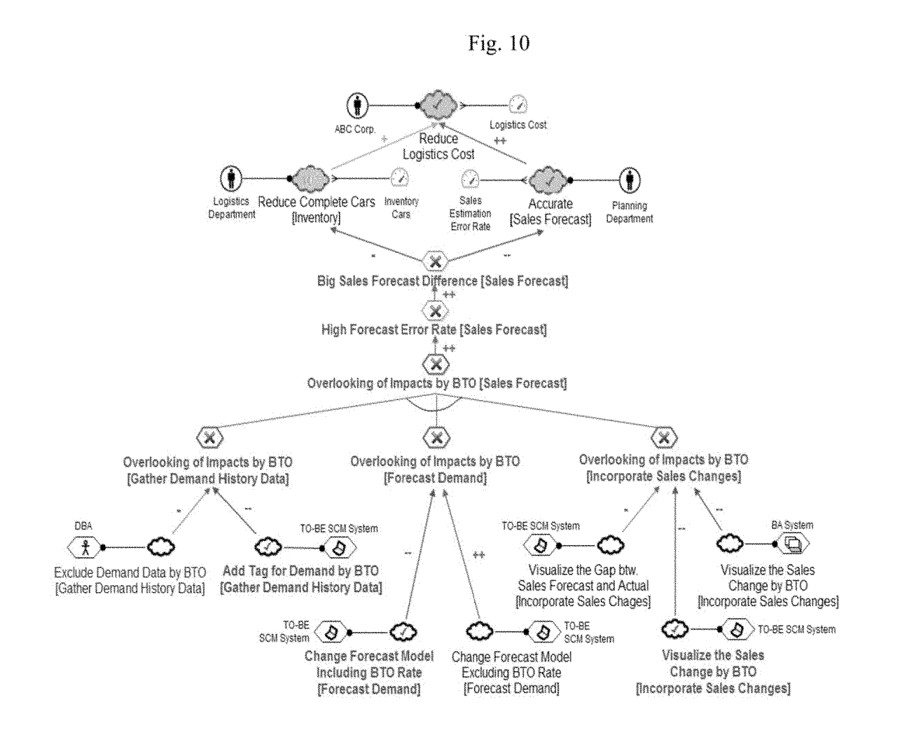

FIG. 10 is a view illustrating an example of a process for extracting software system requirements from a business process modified in relation to a car sales business according to an embodiment of the present disclosure.

A conducting agent is set to a to-be-developed system agent. A validated solutions, “Change Forecast Model Including BTO Rate [Forecast Demand]” or “Visualize the Sales Change by BTO [Incorporate Sales Changes]” corresponds to a requirement for software system.

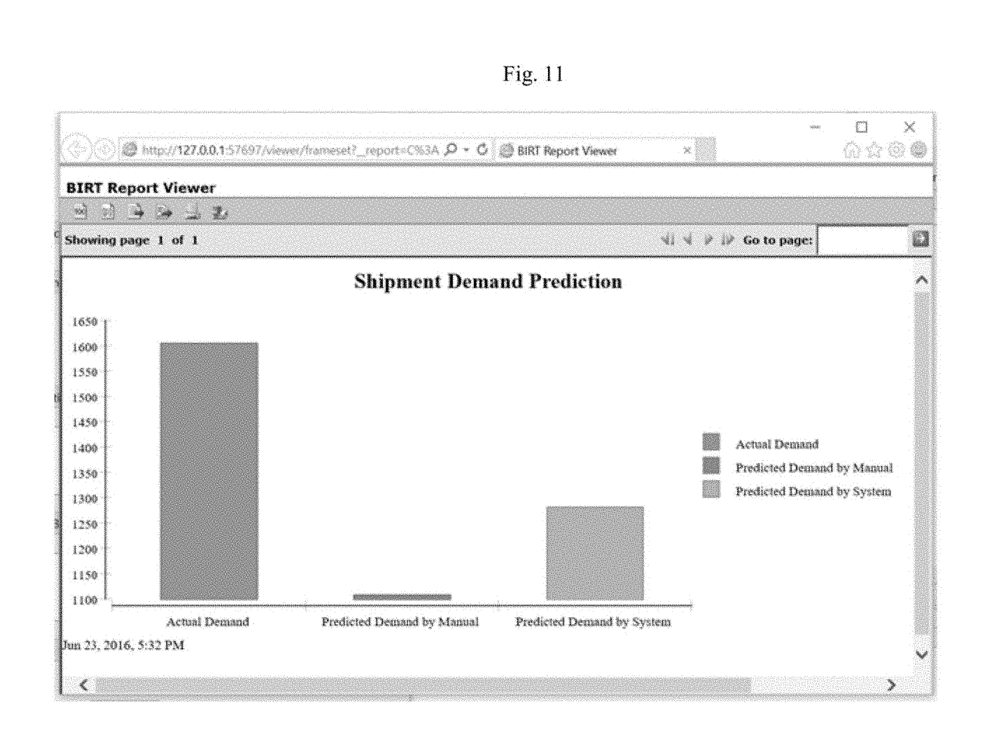

FIG. 11 is a view illustrating examples of screen shots of monitoring a procedure as per a business process modified in relation to a clothing business according to an embodiment of the present disclosure.

A business process designer, stakeholder, user, or operator may visualize a performance process using BIRT which is a reporting tool shown in FIG. 11, check in real-time monitoring information, and apply a feedback to the system.

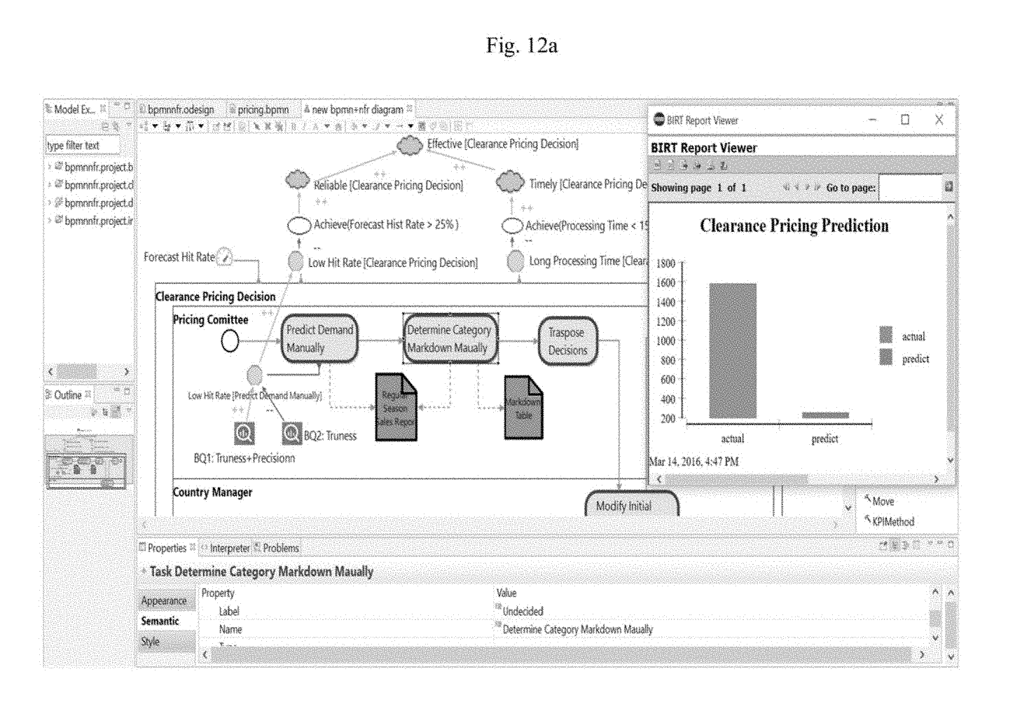

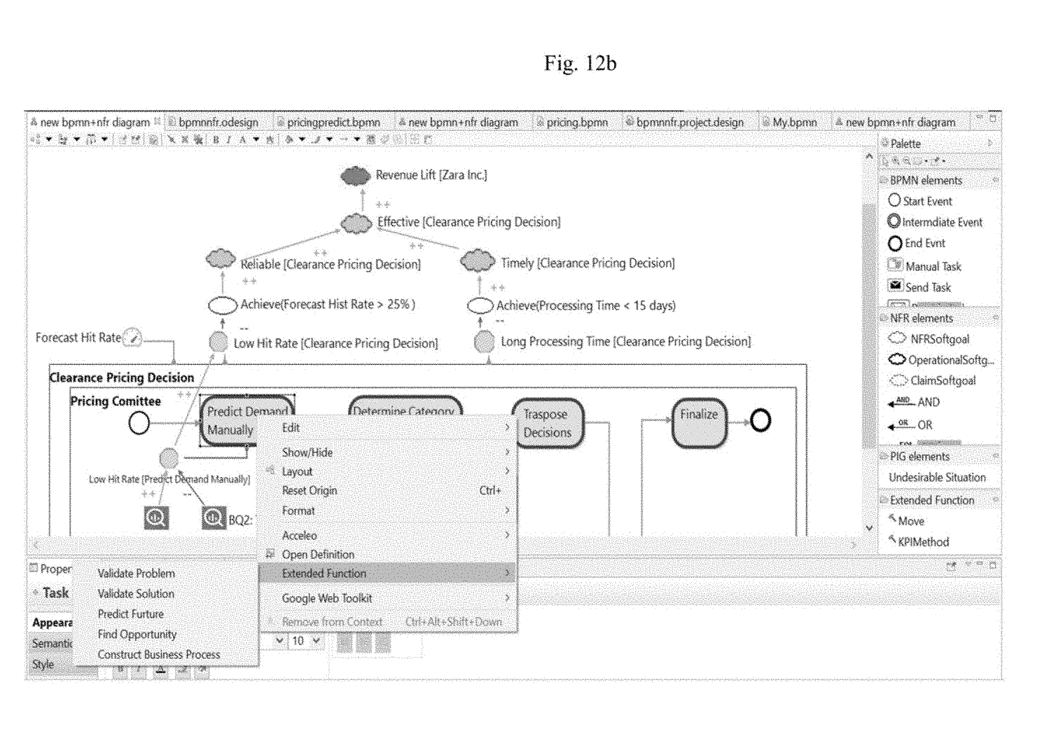

FIGS. 12a and 12b are views illustrating an example of a user interface implemented by a tool for performing a method for executing a computer according to an embodiment of the present disclosure.

Referring to FIGS. 12a and 12b, the UI uses a business context integrated language that is configured based on a soft-goal interdependence graph (SIG), problem interdependence graph (PIG), and business process model and notation (BPMN) in the non-functional requirement (NFR) framework.

According to an embodiment of the present disclosure, there is provided a computer storing a program to execute computer-executable commands or a program for executing at least any one of the above-described computer executed methods of the computing system. The computer may be implemented in the form of a computer-readable storage medium. The computer-readable storage medium may be an available medium that is accessible by a computer. The computer-readable storage medium may include a volatile medium, a non-volatile medium, a separable medium, and/or an inseparable medium. The computer-readable storage medium may include a computer storage medium. The computer storage medium may include a volatile medium, a non-volatile medium, a separable medium, and/or an inseparable medium that is implemented in any method or scheme to store computer-readable commands, data architecture, program modules, or other data or information.

All or some of the components or operations of the present disclosure may be implemented in or by a computer system having a general-purpose hardware architecture or a dedicated computer, computer system, or device.

Although embodiments of the present disclosure have been described with reference to the accompanying drawings, it will be appreciated by one of ordinary skill in the art that the present disclosure may be implemented in other various specific forms without changing the essence or technical spirit of the present disclosure. Thus, it should be noted that the above-described embodiments are provided as examples and should not be interpreted as limiting. Each of the components may be separated into two or more units or modules to perform its function(s) or operation(s), and two or more of the components may be integrated into a single unit or module to perform their functions or operations.

It should be noted that the scope of the present disclosure is defined by the appended claims rather than the described description of the embodiments and include all modifications or changes made to the claims or equivalents of the claims.

What is claimed is:

1. A method performed by a computing system performing goal-oriented big data business analytics, the method comprising the steps of:
setting up a business goal, a business process goal that is a goal for an activity or task related to a process for achieving the business goal, and an performance goal for the business goal or the business process goal;
modeling a hypothesized solution under a hypothesis where a first phenomenon is a solution that is a phenomenon positively contributing to achieving at least any one of the business goal, the business process goal, and the performance goal;
determining that the hypothesized solution is a validated solution when the hypothesized solution is determined to make a positive contribution based on a result of analysis of first big data on the hypothesized solution by a big data analytics platform connected with the computing system;
modeling a plurality of business process alternatives by modifying the activity or task based on a plurality of validated solutions determined by the determining step;
assessing a degree of an influence that each of the business process alternatives has on at least any one of the business goal, the business process goal, and the performance goal; and
determining a core validated solution of the plurality of validated solutions based on a result of the assessment, wherein the degree of the influence is previously divided into a plurality of labels indicating a positive degree or a negative degree.

2. The method of claim 1, further comprising the steps of:
modeling a hypothesized problem under a hypothesis where a second phenomenon corresponds to a problem that is a phenomenon negatively contributing to achieving at least any one of the business goal, the business process goal, and the performance goal; and
determining that the hypothesized problem is a validated problem when the hypothesized problem is determined to be a phenomenon making a negative contribution based on a result of analysis of second big data on the hypothesized problem by the big data analytics platform, wherein modeling the hypothesized solution includes modeling the hypothesized solution under a hypothesis where the first phenomenon corresponds to the solution that is a phenomenon capable of addressing the validated problem.

3. The method of claim 2, further comprising the step of providing a user interface (UI) configured to visualize data corresponding to a result of performing at least one of the steps and display the visualized data.

4. The method of claim 3, wherein the step of providing the UI includes a business context integrated language configured based on a soft-goal interdependence graph, a problem interdependence graph, and a business process model and notation in a non-functional requirement framework.

5. The method of claim 4, wherein the business context integrated language models the big data and a big query on a big data analytics platform configured to analyze the big data.

6. The method of claim 4, wherein the hypothesized problem, the validated problem, the hypothesized solution, and the validated solution are represented in a combination of a Type item and a Topic item, wherein the Type item indicates a non-functional attribute value, and the Topic item indicates a functional attribute value corresponding to the Type item, and wherein the Topic item corresponds to an element constituting a business process written in a business process model and notation.

7. The method of claim 2, wherein the step of modeling the hypothesized problem includes modeling multiple hypothesized problems for the first phenomenon by negating the performance goal, and the step of modeling the hypothesized solution includes modeling multiple hypothesized solutions for the second phenomenon by negating the validated problem.

8. The method of claim 2, wherein the task or activity includes a plurality of sub activities or sub tasks configured in hierarchy, wherein the step of modeling the hypothesized problem uses at least one of a top-down scheme in which the sub tasks or sub activities are reviewed from an outermost sub task or sub activity to an innermost sub task or sub activity, a bottom-up scheme in which the sub tasks or sub activities are reviewed from the innermost sub task or sub activity to the outermost sub task or sub activity, and a hybrid scheme which is a combination of the top-down scheme and the bottom-up scheme to model a root cause for multiple hypothesized problems for the first phenomenon, and wherein the step of modeling the hypothesized solution uses at least one of the top-down scheme, the bottom-up scheme, and the hybrid scheme to model a core hypothesized solution of the multiple hypothesized solutions for the second phenomenon.

9. The method of claim 2, further comprising the steps of:
selecting a core validated solution of the plurality of validated solutions based on a result of assessing a degree of a positive influence that the plurality of validated solutions have on the achievement of at least any one of the business goal, the business process goal, and the performance goal;
selecting a core validated problem of a plurality of validated problems determined by the determining step based on a result of assessing a degree of a negative influence that the plurality of validated problems have on the achievement of at least any one of the business goal, the business process goal, and the performance goal; and
selecting a final business process alternative of the plurality of business process alternatives based on at least one of the core validated solution, the core validated problem, and the results of the assessment.

10. The method of claim 2, further comprising the steps of:
comparing advantages and disadvantages of a plurality of conducting agents according to a label propagation algorithm to select a final conducting agent; and
assigning one activity or task of the plurality of business process alternatives to the final conducting agent.

11. The method of claim 10, further comprising the steps of:
collecting and analyzing monitoring information about a process of performing the assigned activity or task by the final conducting agent; and
resetting at least any one of the business goal, the business process goal, and the performance goal based on the monitoring information.

12. The method of claim 1, wherein the business goal, the business process goal, and the performance goal each are set to depend upon a stakeholder of a business.

13. The method of claim 1, wherein a big query configured to analyze the big data is configured in at least any one of a structured query language (SQL) language, a non-SQL (NoSQL) language, and a language for a machine learning algorithm-based analysis and is used to query about multiple databases (DBs) stored in an integrated big data platform.

14. The method of claim 1, further comprising the step of performing, by a label propagation algorithm, at least one of comparing advantages and disadvantages of a plurality of big queries configured to analyze the big data to select a final big query, comparing advantages and disadvantages of a plurality of validated problems to select a final validated problem, comparing advantages and disadvantages of the plurality of validated solutions to select a final validated solution, and comparing advantages and disadvantages of a plurality of business process alternatives to select a final business process alternative.

15. The method of claim 1, further comprising the step of configuring a business goal-business process map that indicates whether a higher business process positively or negative contributes to the achievement of the business goal using an analysis of a correlation between the performance goal and the activity or task.

16. The method of claim 1, wherein the big data is analyzed by a machine learning algorithm, and wherein the big data includes analysis data for an inter-data correlation, optimization data, and prediction data.

17. The method of claim 1, wherein the steps of the method are executed by a program stored in a computer-readable storage medium.

18. A computing system performing goal-oriented big data business analytics, the computing system comprising:
a memory storing a plurality of commands; and
a processor connected with the memory, wherein the plurality of commands are executed to enable the processor to perform the operations of setting up a business goal, a business process goal that is a goal for an activity or task related to a process for achieving the business goal, and an performance goal for the business goal or the business process goal, modeling a hypothesized problem under a hypothesis where a first phenomenon corresponds to a problem that is a phenomenon negatively contributing to achieving at least any one of the business goal, the business process goal, and the performance goal, determining that the hypothesized problem is a validated problem when the hypothesized problem is determined to make a negative contribution based on a result of analysis of first big data on the hypothesized problem by a big data analytics platform connected with the computing system, modeling a hypothesized solution under a hypothesis where a second phenomenon is a solution that is a phenomenon positively contributing to achieving at least any one of the business goal, the business process goal, and the performance goal or capable of addressing the validated problem, determining that the hypothesized solution is a validated solution when the hypothesized solution is determined to make a positive contribution based on a result of analysis of second big data on the hypothesized solution by the big data analytics platform, modeling a plurality of business process alternatives by modifying the activity or task based on a plurality of validated solutions determined by the determining operation, assessing a degree of an influence that each of the business process alternatives has on at least any one of the business goal, the business process goal, and the performance goal, and determining a final validated problem of a plurality of validated problems or a final validated solution of the plurality of validated solutions based on a result of the assessment, wherein the degree of the influence is previously divided into a plurality of labels indicating a positive degree or a negative degree.

19. The computing system of claim 18, further comprising a user interface (UI) configured to visualize data corresponding to a result of performing at least one of the commands and display the visualized data.

20. A system providing goal-oriented big data business analytics framework, the goal-oriented big data business analytics comprising:
a business context modeler modeling and processing components including a business goal, a business process goal that is a goal for an activity or task related to a process for achieving the business goal, an performance goal for the business goal or the business process goal, and a problem and solution related to the activity or task and displaying the components on a screen of a display;
an integrated big data platform collecting and storing multiple pieces of data; a big data analytics platform analyzing data of the integrated big data platform and validating a hypothesis made for the problem and solution based on a result of the analysis; and
a data visualizer displaying data corresponding to the result of the analysis and a result of the validation on the screen, wherein the system models a plurality of business process alternatives by modifying the activity or task based on a plurality of validated solutions, assesses a degree of an influence that each of the plurality of business process alternatives has on achieving at least any one of the business goal, the business process goal, and the performance goal, and determines a final validated problem among a plurality of validated problems or a final validated solution among the plurality of validated solutions based on a result of the assessment of each business process alternative, and wherein the degree of the influence is previously divided into a plurality of labels indicating a positive degree or a negative degree.
